(19) United States
(12) Patent Application Publication
(10) Pub. No.: US 2020/0318942 A1
(43) Pub. Date: Oct. 8, 2020

(54) OBSERVATION TARGET OBJECT COVER, CONTAINER FOR INTERFERENCE OBSERVATION, INTERFERENCE OBSERVATION DEVICE, AND INTERFERENCE OBSERVATION METHOD

(71) Applicant: HAMAMATSU PHOTONICS K.K., Hamamatsu-shi, Shizuoka (JP)

(72) Inventors: Toyohiko YAMAUCHI, Hamamatsu-shi, Shizuoka (JP); Hidenao YAMADA, Hamamatsu-shi, Shizuoka (JP); Kentaro GOTO, Hamamatsu-shi, Shizuoka (JP)

(73) Assignee: HAMAMATSU PHOTONICS K.K., Hamamatsu-shi, Shizuoka (JP)

(21) Appl. No.: 16/954,223

(22) PCT Filed: Oct. 11, 2018
(86) PCT No.: PCT/JP2018/037952

§ 371 Date: Jun. 16, 2020

(30) Foreign Application Priority Data
Dec. 20, 2017 (JP) 2017-243924

(51) Int. Cl. G01B 9/02; G01N 21/01; G01N 21/45

(52) U.S. Cl. CPC G01B 9/02; G01N 21/45; G01N 21/01

(57) ABSTRACT

Provided is an observation target cover for interference observation using first light and second light having a coherent length longer than that of the first light so as to acquire an interference light image of an observation target by the first light while adjusting an optical path length difference based on an interference result of the second light, the observation target cover including: a transmission reflection portion that transmits the first light and reflects the second light; and a support portion for supporting the transmission reflection portion so that a placement surface on which the observation target is placed and the transmission reflection portion face each other with a predetermined gap therebetween.

### TECHNICAL FIELD

An aspect of the present disclosure relates to an observation target cover, a container for interference observation, an interference observation device, and an interference observation method.

### BACKGROUND ART

As an interference observation device, one using first light and second light having a coherent length longer than that of the first light so as to acquire an interference light image of an observation target by the first light while adjusting an optical path length difference based on an interference result of the second light is known (for example, see Patent Literature 1).

### CITATION LIST

### Patent Literature

Patent Literature 1: Japanese Unexamined Patent Publication No. 2009-122033

### SUMMARY OF INVENTION

### Technical Problem

In the above-described interference observation, it is desirable to relax observation conditions from the viewpoint of improving convenience. Here, an aspect of the present disclosure is to provide an observation target cover, a container for interference observation, an interference observation device, and an interference observation method capable of realizing interference observation with relaxed observation conditions.

### Solution to Problem

An observation target cover according to an aspect of the present disclosure is an observation target cover for interference observation using first light and second light having a coherent length longer than that of the first light so as to acquire an interference light image of an observation target by the first light while adjusting an optical path length difference based on an interference result of the second light, and includes: a transmission reflection portion which transmits the first light and reflects the second light; and a support portion which supports the transmission reflection portion so that a placement surface on which the observation target is placed and the transmission reflection portion face each other with a predetermined gap therebetween.

In the observation target cover, the transmission reflection portion is supported so that the placement surface on which the observation target is placed and the transmission reflection portion face each other with a predetermined gap therebetween. When performing interference observation using the observation target cover, the first light and the second light are incident on the transmission reflection portion from the side opposite to the placement surface while the observation target is placed on the placement surface and the placement surface and the transmission reflection portion face each other with a predetermined gap therebetween. Among these lights, the second light is reflected by the transmission reflection portion and the first light is transmitted through the transmission reflection portion, is reflected by the observation target, and is transmitted through the transmission reflection portion again so as to be returned to the incident side. Thus, according to the observation target cover, it is possible to perform interference observation without the second light being incident on the observation target. As a result, since it is not necessary to consider the influence of the second light on the observation target, it is possible to increase the degree of freedom in selecting characteristic (for example, wavelength) of the second light. Further, since the second light is not incident on the observation target, it is possible to observe not only the observation target having light transmissivity but also the observation target not having light transmissivity. In this way, according to the observation target cover, it is possible to realize interference observation with relaxed observation conditions.

In the observation target cover according to an aspect of the present disclosure, the support portion may include a first plate portion and a second plate portion which is connected to the first plate portion and the transmission reflection portion so that a step is formed between the first plate portion and the transmission reflection portion and the support portion may support the transmission reflection portion so that the transmission reflection portion is located on the side of the placement surface with respect to the first plate portion in an incident direction of the first light. In this case, since the transmission reflection portion can be put closer to the placement surface (the observation target), the occurrence of noise can be prevented. Further, for example, when the objective lens is disposed on the side opposite to the placement surface with respect to the transmission reflection portion, the objective lens can be disposed in a space defined by the second plate portion and the transmission reflection portion. As a result, since the objective lens can be put closer to the transmission reflection portion, a distance between the objective lens and the placement surface (the observation surface) can be easily accommodated in the working distance of the objective lens.

In the observation target cover according to an aspect of the present disclosure, the second plate portion may extend so as to be inclined with respect to the incident direction of the first light so that a space defined by the second plate portion and the transmission reflection portion is widened as it goes away from the transmission reflection portion. In this case, for example, when the objective lens is disposed on the side opposite to the placement surface with respect to the transmission reflection portion, the objective lens can be easily disposed in the space.

In the observation target cover according to an aspect of the present disclosure, a space defined by the second plate portion and the transmission reflection portion may have a circular shape in a cross-section orthogonal to the incident direction of the first light. In this case, for example, when the objective lens is disposed on the side opposite to the placement surface with respect to the transmission reflection portion, the objective lens can be more easily disposed in the space.

In the observation target cover according to an aspect of the present disclosure, the support portion may further include a third plate portion extending from the first plate portion so as to face the second plate portion. In this case, the transmission reflection portion can be appropriately supported by the support portion.

In the observation target cover according to an aspect of the present disclosure, the transmission reflection portion may include a substrate having light transmissivity and an optical layer provided on a surface facing the side of the placement surface in the substrate so as to transmit the first light and reflect the second light. In this case, since the optical layer can be put closer to the placement surface (the observation target), the occurrence of noise can be further prevented.

A container for interference observation according to an aspect of the present disclosure includes: an observation target cover; and a holding member including a bottom wall portion provided with the placement surface and a side wall portion extending from the bottom wall portion in a direction orthogonal to the placement surface, and the observation target cover is disposed on the side wall portion so that the placement surface and the transmission reflection portion face each other with a predetermined gap therebetween. According to the container for interference observation, since interference observation can be performed without the second light being incident on the observation target due to the above-described reason, it is possible to realize interference observation with relaxed observation conditions. Further, since the holding member includes the side wall portion and the observation target cover is disposed on the side wall portion, the container for interference observation can be easily handled.

In the container for interference observation according to an aspect of the present disclosure, the observation target cover may be attached to the holding member so that a space between the observation target cover and the holding member is sealed. In this case, the contamination of the observation target due to foreign matter in external air can be prevented.

In the container for interference observation according to an aspect of the present disclosure, the side wall portion may be provided with a first screw portion, the support portion may include a fourth plate portion extending in the incident direction of the first light, the side wall portion may be provided with the first screw portion, the fourth plate portion may be provided with a second screw portion screwed to the first screw portion, and the observation target cover may be attached to the holding member by screwing the first screw portion and the second screw portion to each other. In this case, the observation target cover and the holding member can be strongly fixed to each other. Further, a distance between the transmission reflection portion and the placement surface (the observation target) can be adjusted by changing the screwing amount between the first screw portion and the second screw portion.

An interference observation device according to an aspect of the present disclosure includes: the observation target cover; a first light source which outputs the first light; a second light source which outputs the second light; an interference optical system which outputs interference light of the first light and interference light of the second light; a first light detector which detects the interference light of the first light; a second light detector which detects the interference light of the second light; and a holding member provided with the placement surface. According to the interference observation device, since interference observation can be performed without the second light being incident on the observation target due to the above-described reason, it is possible to realize interference observation with relaxed observation conditions.

An interference observation method according to an aspect of the present disclosure is an interference observation method using the interference observation device, and includes: a first step of placing the observation target on the placement surface; a second step of disposing the observation target cover so that the placement surface and the transmission reflection portion face each other with a predetermined gap therebetween after the first step; and a third step of acquiring an interference light image of the observation target by the first light while adjusting the optical path length difference based on the interference result of the second light after the second step. According to the interference observation method, since it is possible to perform interference observation without the second light being incident on the observation target due to the above-described reason, it is possible to realize interference observation with relaxed observation conditions.

### Advantageous Effects of Invention

According to an aspect of the present disclosure, it is possible to provide an observation target cover, a container for interference observation, an interference observation device, and an interference observation method capable of realizing interference observation with relaxed observation conditions.

### BRIEF DESCRIPTION OF DRAWINGS

FIG. 1 is a configuration diagram of an interference observation device according to an embodiment.

FIG. 2 is a diagram illustrating a relationship between the intensity and an optical path length difference of first and second lights.

FIG. 3 is a diagram for describing an optical path length difference adjustment operation.

FIG. 4 is a flowchart illustrating a process procedure in a first operation mode.

FIG. 5 is a diagram illustrating a time change of an optical path length difference in the first operation mode.

FIG. 6 is a flowchart illustrating a process procedure in a second operation mode.

FIG. 7 is a diagram illustrating a time change of an optical path length difference in the second operation mode.

FIG. 8 is a cross-sectional view of a container for interference observation according to an embodiment.

FIG. 9 is an exploded perspective view of the container for interference observation illustrated in FIG. 8.

FIG. 10 is a cross-sectional view of a container for interference observation according to a first modified example.

FIG. 11 is a cross-sectional view of a container for interference observation according to a second modified example.

FIG. 12 is an exploded perspective view of a container for interference observation according to a third modified example.

FIG. 13 is a cross-sectional view of the container for interference observation according to the third modified example.

FIG. 14 is a diagram showing an interference light image acquired in a first example.

FIGS. 15(a) to 15(c) are diagrams showing a reflected light intensity image acquired in the first example.

FIG. 16(a) is a diagram showing an interference light image acquired in a second example and FIG. 16(b) is a diagram showing a reflection intensity image acquired in the second example.

FIG. 17(a) is a diagram showing a phase image of FIGS. 16(a) and 16(b) and FIG. 17(b) is a diagram showing a phase image after phase unwrapping with respect to the phase image of FIG. 17(a).

### DESCRIPTION OF EMBODIMENTS

Hereinafter, an embodiment of the present disclosure will be described in detail with reference to the drawings. Additionally, in the description below, the same or corresponding components will be denoted by the same reference numerals and redundant description will be omitted.

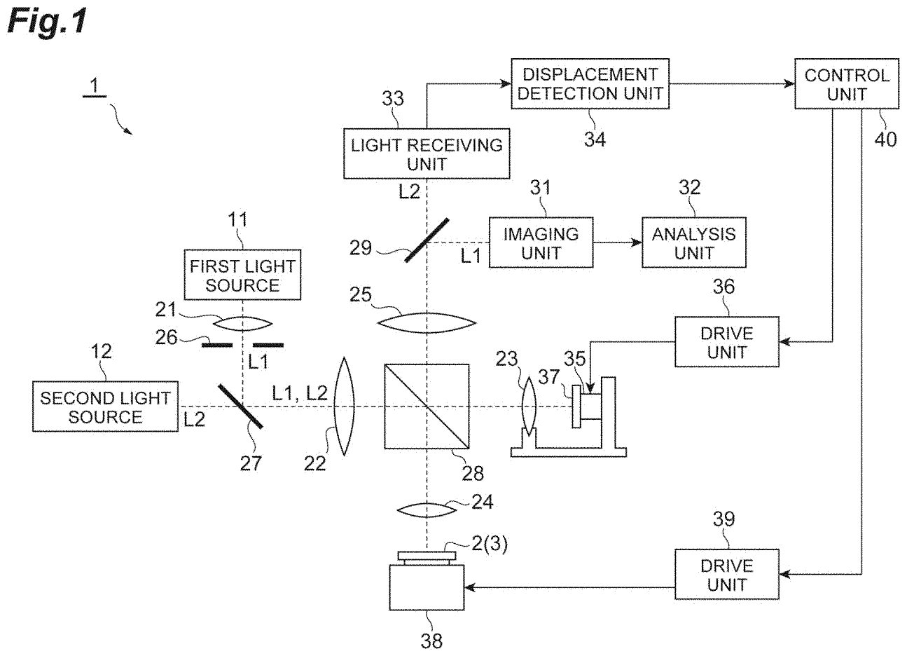

An interference observation device 1 illustrated in FIG. 1 is a device for observing a surface or an inside of an observation target 3 accommodated in a container (a container for interference observation) 2. As an example of the observation target 3, for example, a biological sample such as a cell or an industrial sample such as an electronic component or a metal work piece can be exemplified. The detail of the container 2 will be described later. The interference observation device 1 includes, in addition to the container 2, a first light source 11, a second light source 12, lenses 21 to 25, an aperture 26, an optical multiplexer 27, a half mirror 28, an optical splitter 29, an imaging unit 31, an analysis unit 32, a light receiving unit 33, a displacement detection unit 34, a piezo actuator 35, a drive unit 36, a mirror 37, a stage 38, a drive unit 39, and a control unit 40. The container 2 is placed on the stage 38.

The first light source 11 outputs incoherent first light L1. The first light source 11 is, for example, a tungsten lamp or a halogen lamp that outputs broadband light with a wavelength band of 400 nm to 1000 nm, a white LED that outputs broadband light with a wavelength band of 500 nm to 700 nm, a single-color LED that outputs incoherent light with a wavelength band of 610 nm to 640 nm, or a light source configured by performing optical wavelength-filtering on light output from a single-color LED to a wavelength width of about 3 nm, or the like. The coherent length (coherence length) when a tungsten lamp or a halogen lamp is used as the first light source 11 is, for example, 1 μm to 5 μm. The coherent length when an LED is used as the first light source 11 is, for example, 2 μm to 20 μm. The coherent length when a wavelength-filtered LED is used as the first light source 11 is, for example, 50 μm to 100 μm. The second light source 12 outputs coherent second light L2. The coherent length of the second light L2 is longer than the coherent length of the first light L1 and is, for example, 1000 μm or more. The second light L2 has a wavelength longer or shorter than the wavelength band of the first light L1. The second light source 12 is, for example, a semiconductor laser light source that outputs laser light having a wavelength of 1.31 μm as the second light L2 or a semiconductor laser light source that outputs laser light having a wavelength of 780 μm as the second light L2. The second light source 12 may be a helium neon laser light source having a coherent length of 1 in or more, a DFB type semiconductor laser light source having a coherent length of 10 mm or more, a Fabry-Perot semiconductor laser light source having a coherent length of about 1 mm to 2 mm, or a surface-emitting type semiconductor laser light source having a coherent length of about several mm.

The optical multiplexer 27 reflects the first light L1 output from the first light source 11, passing through the lens 21 and the aperture 26, and reaching the optical multiplexer and transmits the second light L2 output from the second light source 12 and reaching the optical multiplexer. The optical multiplexer 27 multiplexes the first light L1 and the second light L2 and outputs the multiplexed light to the lens 22.

The half mirror 28 branches the multiplexed light output from the optical multiplexer 27, passing through the lens 22, and reaching the half mirror into first and second branched lights, outputs the first branched light to the lens 23, and outputs the second branched light to the lens 24. The half mirror 28 receives first reflected light, which is generated by the first branched light passing through the lens 23 and reflected by the mirror 37, through the lens 23 again and receives second reflected light, which is generated by the second branched light passing through the lens 24 and reflected by the surface or the inside of the observation target 3, through the lens 24 again. The half mirror 28 outputs the interference light to the lens 25 by causing the first reflected light and the second reflected light to interfere with each other. The half mirror 28 constitutes an interference optical system.

The optical splitter 29 receives the interference light output from the half mirror 28 and passing through the lens 25, reflects the first light L1 included in the interference light to be output to the imaging unit 31, and transmits the second light L2 included in the interference light to be output to the light receiving unit 33. The lenses 23 to 25 constitute an imaging optical system which forms an image of the first light L1 output from the half mirror 28 and split by the optical splitter 29 on the imaging surface of the imaging unit 31. The lens 23 is an objective lens disposed so as to face the mirror 37 and the lens 24 is an objective lens disposed so as to face the container 2 on the stage 38. The imaging unit 31 constitutes a first light detector which detects the interference light of the first light L1. The imaging unit 31 captures the interference light image of the formed first light L1. The imaging unit 31 is, for example, an imaging element such as a CCD camera and a CMOS camera. The light receiving unit 33 constitutes a second light detector which detects the interference light of the second light L2. The light receiving unit 33 detects the intensity of the second light L2 output from the half mirror 28 and split by the optical splitter 29. The light receiving unit 33 is, for example, a light receiving element such as a single photodiode or a one-dimensional photodiode array.

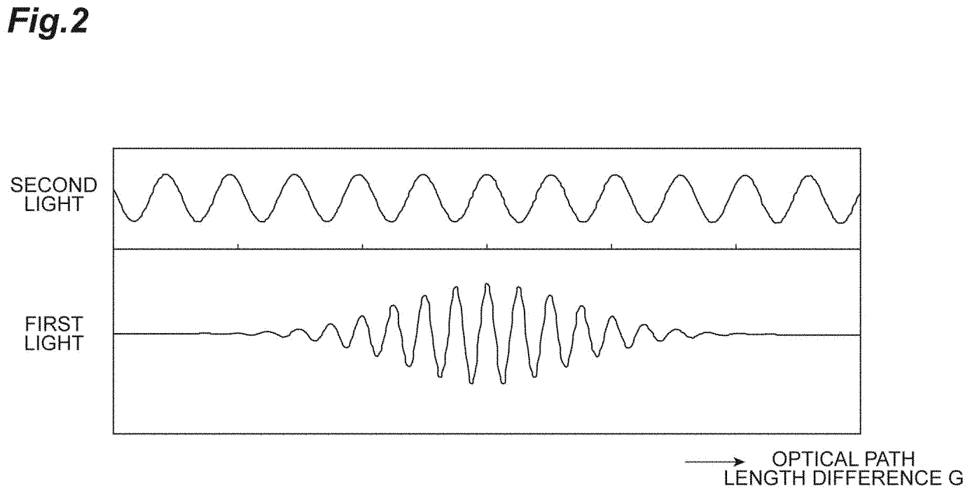

Here, G denotes an optical path length difference between an optical path length of the light from the half mirror 28 reflected by the mirror 37 and reaching the half mirror 28 again and an optical path length of the light from the half mirror 28 reflected by the reference position in the observation target 3 and reaching the half mirror 28 again. That is, the optical path length difference G is an optical path length difference between the first reflected light and the second reflected light. As described above, since the coherent length of the second light L2 output from the second light source 12 and reaching the light receiving unit 33 is relatively long, as illustrated in FIG. 2, the intensity of the second light L2 reaching the light receiving unit 33 periodically changes in the relatively wide range of the optical path length difference G In contrast, since the coherent length of the first light L1 output from the first light source 11 and reaching the imaging unit 31 is relatively short, as illustrated in FIG. 2, the intensity of the first light L1 reaching the imaging unit 31 periodically changes in the relatively narrow range of the optical path length difference G Further, in the case of the first light L1, the amplitude of the interference is larger as the optical path length difference G is closer to the value 0.

By using this, the analysis unit 32 acquires the interference light image of the first light L1 captured by the imaging unit 31 when the optical path length difference G is set to each of a plurality of target values. The analysis unit 32 performs a predetermined analysis based on the acquired interference light image. The displacement detection unit 34 detects the optical path length difference G based on a change in the intensity of the second light L2 detected by the light receiving unit 33. That is, the light receiving unit 33 and the displacement detection unit 34 constitute an optical path length difference detection unit for detecting the optical path length difference G.

The piezo actuator 35, the drive unit 36, the stage 38, and the drive unit 39 constitute an optical path length difference adjustment unit for adjusting the optical path length difference G The piezo actuator 35 is driven by the drive unit 36 and moves the mirror 37 in a direction parallel to the optical axis of the optical system between the half mirror 28 and the mirror 37. The stage 38 is driven by the drive unit 39 and moves the container 2 (the observation target 3) in a direction parallel to the optical axis of the optical system between the half mirror 28 and the observation target 3. The operation range of the piezo actuator (the first movable portion) 35 is narrower than the movable range of the stage (the second movable portion) 38 and the position accuracy of the piezo actuator 35 is higher than the position accuracy of the stage 38.

The control unit 40 controls an optical path length difference adjustment operation using the piezo actuator 35 and the stage 38 so that the optical path length difference G becomes sequentially the plurality of target values based on the detection result of the optical path length difference G by the displacement detection unit 34. The control unit 40 is configured by, for example, a computer including a processor and performs each process using the processor.

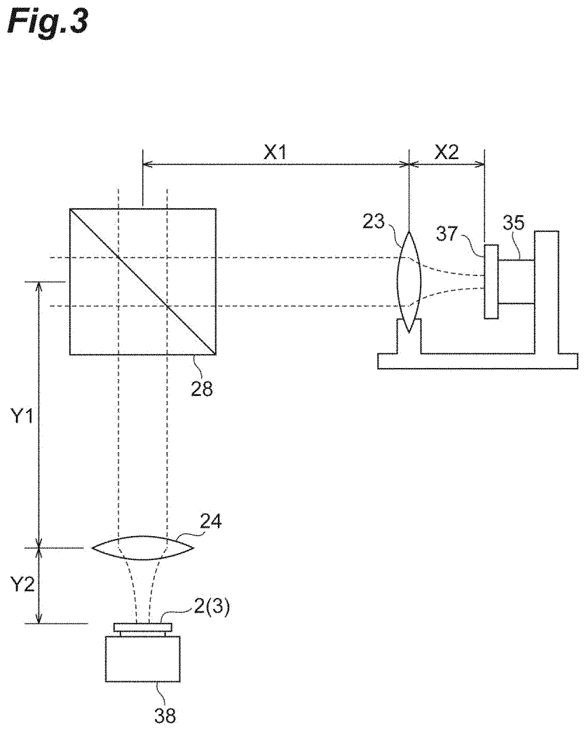

FIG. 3 is a diagram for describing an optical path length difference adjustment operation. Here, a distance between the half mirror 28 and the lens 23 is denoted by X1 and a distance between the lens 23 and the mirror 37 is denoted by X2. A distance between the half mirror 28 and the lens 24 is denoted by Y1 and a distance between the lens 24 and the observation target 3 is denoted by Y2. The distance Y2 between the lens 24 and the observation target 3 means a distance to the observation surface (slide surface) of the observation target 3. The distance X2 is adjusted by a movement operation of the piezo actuator 35. The distance Y2 is adjusted by a movement operation of the stage 38. When a distance (X1+X2) or a distance (Y1+Y2) is changed by the piezo actuator 35 or the stage 38, the optical path length difference G is adjusted.

The control unit 40 continuously or intermittently performs the movement operation of the stage 38 so that the movement amount of the piezo actuator 35 at each of the plurality of target values is within a predetermined range of the operation range. In addition, the control unit 40 performs feedback control of the movement operation of the piezo actuator 35 so that the optical path length difference G becomes each target value based on the detection result of the optical path length difference G of the displacement detection unit 34 also in the movement operation of the stage 38. Hereinafter, two operation modes will be described as an example.

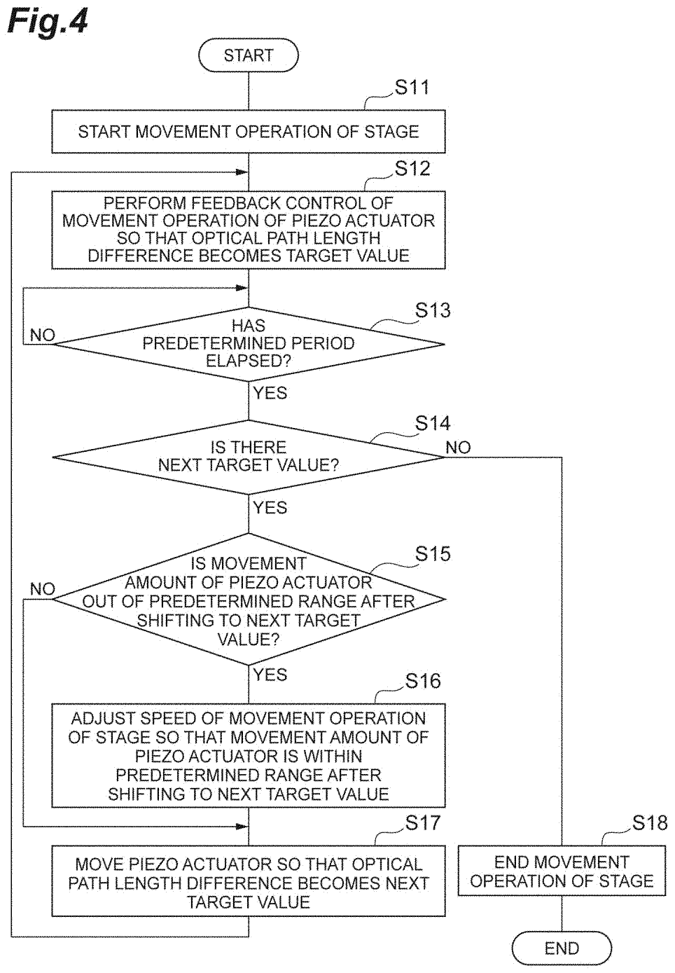

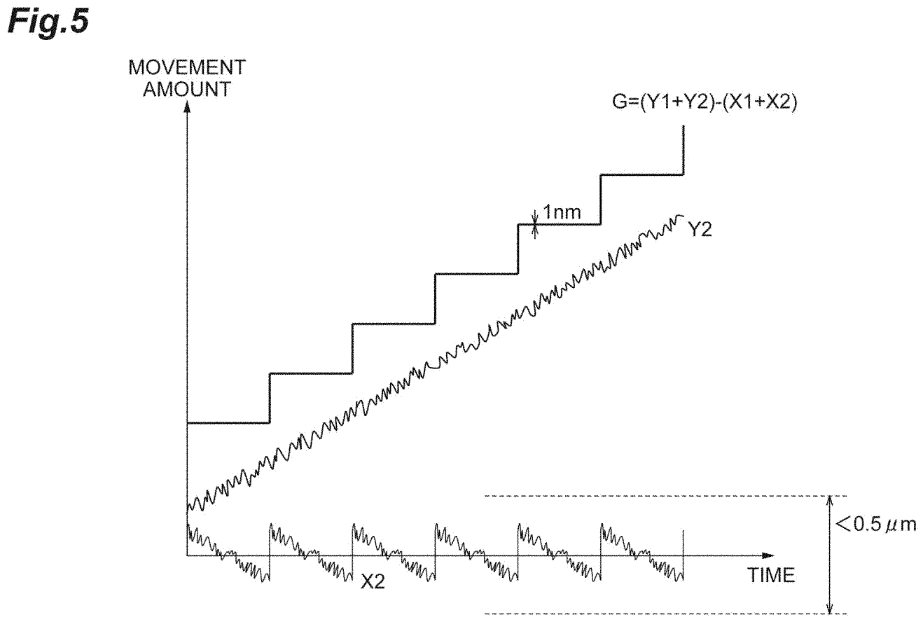

In a first operation mode illustrated in FIGS. 4 and 5, the control unit 40 continuously performs the movement operation of the stage 38. In step S11, the control unit 40 starts the movement operation of the stage 38 through the drive unit 39. Assuming that the optical path length difference G is shifted from a certain target value to the next target value at a predetermined time interval Ta and a change amount of the gap Y2 in this shift operation is Ya, a movement speed of the stage 38 is set to “Ya/Ta”. Accordingly, the gap Y2 between the lens 24 and the observation target 3 substantially linearly changes as time elapses. However, since the position accuracy of the stage 38 is relatively low, a time variation of the gap Y2 is relatively large.

Here, in step S12, the control unit 40 performs feedback control of the movement operation of the piezo actuator 35 via the drive unit 36 so that the optical path length difference G becomes the target value. At this time, the gap X2 is adjusted by the piezo actuator 35 so that the optical path length difference G={(Y1+Y2)−(X1+X2)} is set with high accuracy. In step S13, the control unit 40 determines whether or not a predetermined time interval Ta has elapsed since the optical path length difference is set to a certain target value and proceeds to a process of step S14 when the predetermined time interval Ta has elapsed. In step S14, the control unit 40 determines whether or not a next target value is present, proceeds to a process of step S15 when the next target value is present, and proceeds to a process of step S18 when the next target value is not present.

In step S15, the control unit 40 determines whether or not the movement amount of the piezo actuator 35 is out of a predetermined range at the shifted target value before the optical path length difference G is shifted to the next target value. When it is determined that the movement amount is out of the predetermined range, the control unit 40 proceeds to a process of step S17 through step S16. When it is determined that the movement amount is within the predetermined range, the control unit 40 immediately proceeds to a process of step S17. In step S16, the control unit 40 adjusts a speed of the movement operation of the stage 38 so that the movement amount of the piezo actuator 35 is within a predetermined range after shifting to the next target value.

In step S17, the control unit 40 sets the optical path length difference G to the next target value and moves the piezo actuator 35 via the drive unit 36 in a stepwise manner by a predetermined amount. Then, the control unit 40 performs feedback control of the movement operation of the piezo actuator 35 via the drive unit 36 so that the optical path length difference G becomes a new target value by returning to the process of step S12. In step S18, the control unit 40 ends the movement operation of the stage 38 via the drive unit 39.

According to such a first operation mode, since the control unit 40 controls the movement operation of each of the piezo actuator 35 and the stage 38, both the wide dynamic range of the movement operation of the stage 38 and the high position accuracy of the movement operation of the piezo actuator 35 can be realized and hence the observation target 3 can be observed with high accuracy in the wide dynamic range. Further, on the assumption that the number of the target values of the optical path length difference G is N, if the moving distance when the stage 38 is moved at a constant speed of “Ya/Ta” within the time of N× Ta is sufficiently accurate (for example, an error is ±1 μm or less), steps S15 and S16 are not necessary and a process of step S17 may be performed immediately after step S14.

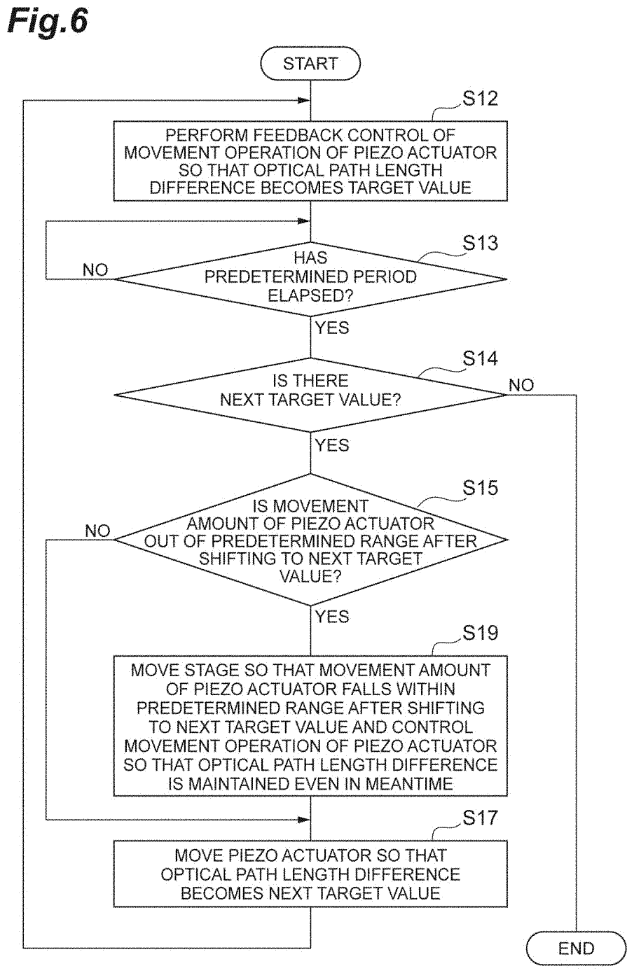

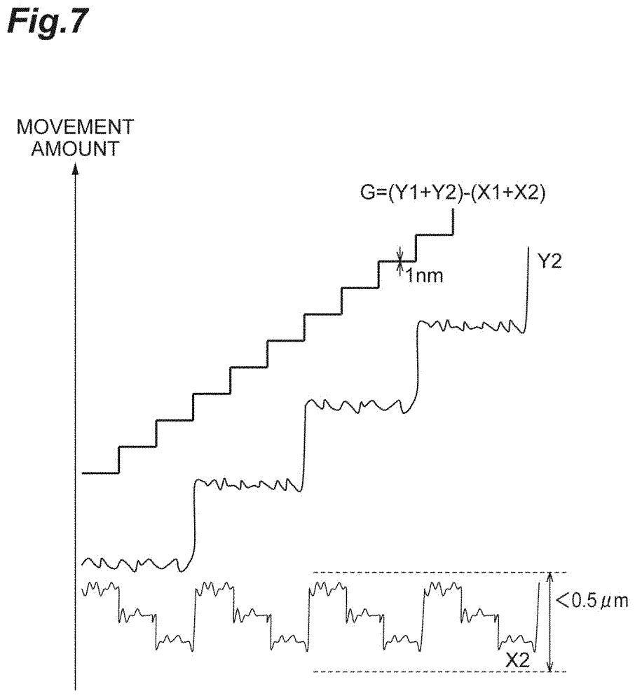

In a second operation mode illustrated in FIGS. 6 and 7, the control unit 40 intermittently performs the movement operation of the stage 38. In the second operation mode, step S11 is omitted and a process of step S12 is promptly performed. For that reason, since the position accuracy of the stage 38 is relatively low although the stage 38 does not move when step S12 is performed, a time variation of the gap Y2 is relatively large. However, the gap X2 is adjusted by the piezo actuator 35 so that the optical path length difference G is highly accurately set by the process of step S12.

In the second operation mode, step S18 is omitted. That is, when it is determined that the next target value is not present in step S14, the control unit 40 ends the process. When it is determined that the next target value is present in step S14, the control unit 40 proceeds to a process of step S19 instead of step S16 and then proceeds to step S17. In step S19, the control unit 40 moves the stage 38 so that the movement amount of the piezo actuator 35 falls within a predetermined range after shifting to the next target value and then stops the stage 38. Further, the control unit 40 controls the movement operation of the piezo actuator 35 so that the optical path length difference G becomes each target value even when the stage 38 moves.

Also in such a second operation mode, both the wide dynamic range of the movement operation of the stage 38 and the high position accuracy of the movement operation of the piezo actuator 35 can be realized and hence the observation target 3 can be observed with high accuracy in the wide dynamic range.

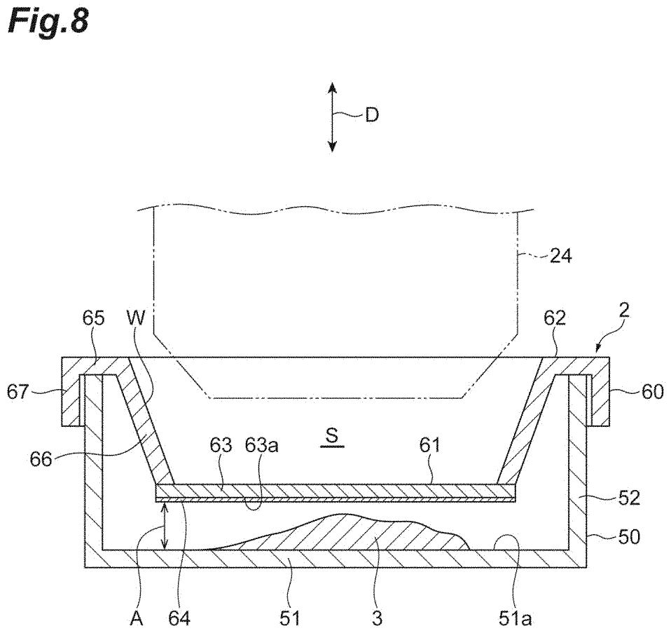

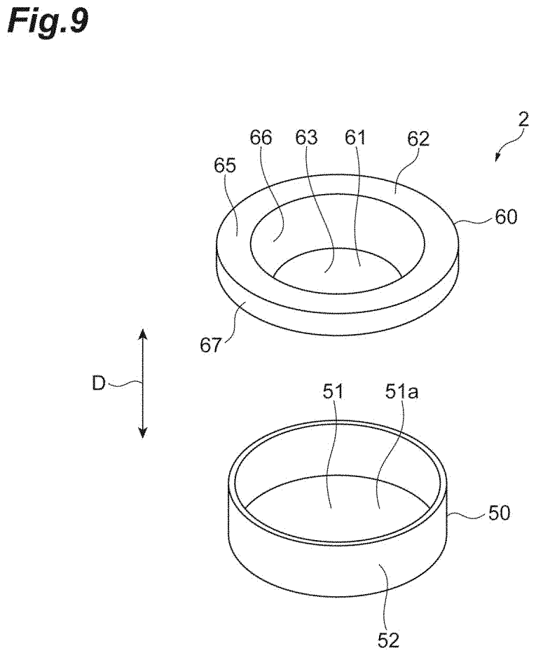

Next, the detail of the container 2 will be described with reference to FIGS. 8 and 9. The container 2 includes a holding member 50 and an observation target cover 60. The holding member 50 is formed of, for example, glass, plastic, or the like and includes a bottom wall portion 51 and a side wall portion 52. The bottom wall portion 51 is formed in, for example, a disk shape and includes a placement surface 51a on which the observation target 3 is placed. The side wall portion 52 extends, for example, from the edge of the bottom wall portion 51 in a direction orthogonal to the placement surface 51a and has a cylindrical shape. In this embodiment, the height of the side wall portion 52 is smaller than the diameter of the bottom wall portion 51. When the observation target 3 is a cell, the holding member 50 may be a general-purpose cell culture dish. A depression may be provided at the center part of the bottom wall portion 51.

The observation target cover 60 includes a transmission reflection portion 61 which transmits the first light L1 and reflects the second light L2 and a support portion 62 which supports the transmission reflection portion 61. The transmission reflection portion 61 includes a substrate 63 and an optical layer 64. The substrate 63 is, for example, formed in a disk shape by using a material having light transmissivity. The optical layer 64 is an optical coating (beam splitter surface) provided over the surface 63a of the substrate 63, transmits the first light L1, and reflects the second light L2. The surface 63a of the substrate 63 is a surface facing the placement surface 51a of the bottom wall portion 51 in a state in which the observation target cover 60 is disposed on the side wall portion 52 (a state illustrated in FIG. 8). Both surfaces of the transmission reflection portion 61 may be provided with a low-reflection layer for the wavelength band of the first light L1.

The support portion 62 includes a first plate portion 65, a second plate portion 66, and a third plate portion 67. For example, the first plate portion 65, the second plate portion 66, and the third plate portion 67 are integrally formed with one another. The support portion 62 may be formed of a transparent material such as plastic or glass or an opaque material such as metal. When the support portion 62 is transparent, the observation target 3 inside the container 2 can be visually checked from the outside.

The first plate portion 65 is, for example, a plate-shaped member that has a circular ring shape when viewed from the incident direction D of the first light L1 with respect to the transmission reflection portion 61. The second plate portion 66 is connected to the first plate portion 65 and the transmission reflection portion 61 (the substrate 63) so that a step W is formed between the first plate portion 65 and the transmission reflection portion 61. Further, the second plate portion 66 is connected to the first plate portion 65 and the transmission reflection portion 61 so that the first plate portion 65 and the transmission reflection portion 61 are disposed in parallel to each other. In this embodiment, the second plate portion 66 is a cylindrical member that extends over the entire circumference between the inner edge of the first plate portion 65 and the outer edge of the transmission reflection portion 61. The transmission reflection portion 61 is fixed to the second plate portion 66 by, for example, adhering.

The second plate portion 66 defines a space S together with the transmission reflection portion 61. The second plate portion 66 extends so as to be inclined with respect to the incident direction D so that the space S is widened as it goes away from the transmission reflection portion 61. That is, the second plate portion 66 has a tapered shape. In this embodiment, the space S has a truncated cone shape and has a circular shape in each cross-section orthogonal to the incident direction D. The transmission reflection portion 61 is disposed at a bottom portion of the space S (an end portion opposite to the first plate portion 65 in the incident direction D). The third plate portion 67 extends from the first plate portion 65 so as to face the second plate portion 66. In this embodiment, the third plate portion 67 extends in the incident direction D from the outer edge of the first plate portion 65 (an edge opposite to the second plate portion 66 in the first plate portion 65) and has a flat cylindrical shape.

The support portion 62 supports the transmission reflection portion 61 so that the placement surface 51a and the transmission reflection portion 61 face each other in parallel with a predetermined gap A therebetween. In this embodiment, as illustrated in FIG. 8, the observation target cover 60 is put on the holding member 50 so that the third plate portion 67 is located at the outside of the side wall portion 52 and the first plate portion 65 is placed on the side wall portion 52. Accordingly, the observation target cover 60 is disposed on the side wall portion 52 and the placement surface 51a and the transmission reflection portion 61 face each other with the gap A therebetween. In this state, the transmission reflection portion 61 is located on the side of the placement surface 51a with respect to the first plate portion 65 in the incident direction D. Further, the second plate portion 66 and the side wall portion 52 face each other and an air gap is formed between the second plate portion 66 and the side wall portion 52. The gap A is set so that a distance between the lens 24 and the placement surface 51a (the observation surface) falls within the working distance of the lens 24. The gap A is, for example, about 0.4 mm.

The container 2 accommodates the observation target 3 by disposing the observation target cover 60 on the side wall portion 52 after placing the observation target 3 on the placement surface 51a. The container 2 is placed on the stage 38 in a state of accommodating the observation target 3. The container 2 is placed on the stage 38 so that the transmission reflection portion 61 and the placement surface 51a are located on the optical path of the second branched light (the optical path between the half mirror 28 and the observation target 3). Accordingly, the second branched light output from the half mirror 28 (the lens 24) can be incident on the transmission reflection portion 61.

In the case of interference observation, first, the observation target 3 is placed on the placement surface 51a (a first step). Next, the observation target cover 60 is disposed so that the placement surface 51a and the transmission reflection portion 61 face each other with the gap A therebetween (a second step). Next, the container 2 is placed on the stage 38 so that the transmission reflection portion 61 and the placement surface 51a are located on the optical path of the second branched light. These operations are performed by, for example, a working machine or an operator. Next, as described above, the interference light image of the observation target 3 by the first light L1 is acquired while the optical path length difference G is adjusted based on the interference result of the second light L2 (a third step).

Next, an function and an effect of the observation target cover 60 will be described. As described above, in the observation target cover 60, the transmission reflection portion 61 is supported so that the placement surface 51a and the transmission reflection portion 61 face each other with the gap A therebetween. When performing interference observation using the observation target cover 60, the first light L1 and the second light L2 are incident on the transmission reflection portion 61 from the side opposite to the placement surface 51a while the observation target 3 is placed on the placement surface 51a and the placement surface 51a and the transmission reflection portion 61 face each other with the gap A therebetween. Among these lights, the second light L2 is reflected by the transmission reflection portion 61 and the first light L1 is transmitted through the transmission reflection portion 61, is reflected by the observation target 3, and is transmitted through the transmission reflection portion 61 again so as to return to the incident side. Thus, according to the observation target cover 60, it is possible to perform interference observation without the second light L2 being incident on the observation target 3. As a result, since it is not necessary to consider the influence of the second light L2 on the observation target 3, it is possible to increase the degree of freedom in selecting characteristic (for example, wavelength) of the second light L2. For example, even when the observation target 3 does not have resistance to ultraviolet light, ultraviolet light can be used as the second light L2. Further, since the second light L2 is not incident on the observation target 3, not only the observation target 3 having light transmissivity but also the observation target 3 not having light transmissivity can be observed. As an example of the observation target 3 not having light transmissivity, for example, an opaque industrial sample can be exemplified. In this way, according to the observation target cover 60, it is possible to realize interference observation with relaxed observation conditions.

If a configuration in which a light reflection layer reflecting the first light L1 and the second light L2 is formed on the placement surface 51a is adopted differently from this embodiment, the observation target 3 needs to be placed on the light reflection layer. In this case, there is a possibility that, depending on the type of the observation target 3, an observation result may be affected by placing the observation target 3 on the light reflection layer. For example, when the observation target 3 is a cell and the cell is seeded on the light reflection layer, there is a possibility that the reliability of the observation result may be affected by the culturing of the cell on the light reflection layer instead of a general-purpose cell culture dish. Further, there is also a possibility that traceability to other methods in physiological assessments can be difficult to ensure. In contrast, according to the observation target cover 60 of this embodiment, since the transmission reflection portion 61 is provided separately from the placement surface 51a and the placement surface 51a can have any configuration, the occurrence of such a situation can be prevented.

If a configuration in which a light reflection layer reflecting the first light L1 and the second light L2 is formed on the placement surface 51a is adopted differently from this embodiment, the observation target 3 needs to be placed on the light reflection layer and hence the observation target 3 contacts the light reflection layer. In contrast, according to the observation target cover 60 of this embodiment, since the placement surface 51a and the transmission reflection portion 61 face each other with the gap A therebetween, the observation target 3 does not easily contact the transmission reflection portion 61. For that reason, it is possible to prevent the observation target 3 from being damaged or contaminated. For example, when the observation target 3 is a biological sample, it is possible to prevent the biological sample from being contaminated by bacteria or viruses. Further, when the observation target 3 is an industrial sample, it is possible to prevent the industrial sample from being scratched or stained.

In the observation target cover 60, the second plate portion 66 is connected to the first plate portion 65 and the transmission reflection portion 61 so that the step W is formed between the first plate portion 65 and the transmission reflection portion 61 and the support portion 62 supports the transmission reflection portion 61 so that the transmission reflection portion 61 is located on the side of the placement surface 51a with respect to the first plate portion 65 in the incident direction D. Accordingly, since the transmission reflection portion 61 can be put closer to the placement surface 51a (the observation target 3), the occurrence of noise can be prevented. Further, the lens 24 can be disposed in the space S defined by the second plate portion 66 and the transmission reflection portion 61. As a result, since the lens 24 can be put closer to the transmission reflection portion 61, a distance between the lens 24 and the placement surface 51a (the observation surface) can be easily accommodated in the working distance of the lens 24.

In the observation target cover 60, the second plate portion 66 extends so as to be inclined with respect to the incident direction D so that the space S is widened as it goes away from the transmission reflection portion 61. Accordingly, the lens 24 can be easily disposed in the space S.

In the observation target cover 60, the space S has a circular shape in a cross-section orthogonal to the incident direction D. Accordingly, the lens 24 can be more easily disposed in the space S. This is particularly significant when the lens 24 is a substantially columnar objective lens.

In the observation target cover 60, the support portion 62 includes the third plate portion 67 which extends from the first plate portion 65 so as to face the second plate portion 66. Accordingly, the transmission reflection portion 61 can be appropriately supported by the support portion 62.

In the observation target cover 60, the transmission reflection portion 61 includes the substrate 63 which has light transmissivity and the optical layer 64 which is provided in the surface 63a facing the side of the placement surface 51a in the substrate 63 so as to transmit the first light L1 and reflect the second light L2. Accordingly, since the optical layer 64 can be put closer to the placement surface 51a (the observation target 3), the occurrence of noise can be further prevented.

In the container 2, since the holding member 50 includes the side wall portion 52 and the observation target cover 60 is disposed on the side wall portion 52, the container 2 can be easily handled. Further, in the container 2, the second plate portion 66 and the side wall portion 52 face each other and am air gap is formed between the second plate portion 66 and the side wall portion 52. Accordingly, for example, when the observation target 3 contains a liquid, the liquid can be released into the air gap. This is particularly useful when the observation target 3 is a cell and the liquid is a culture solution.

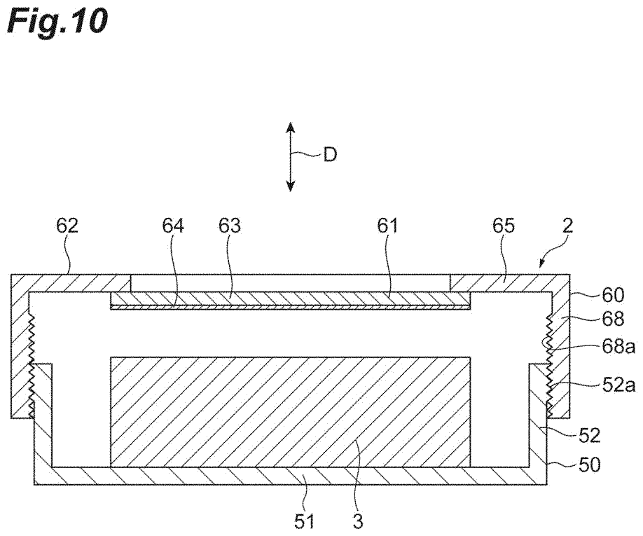

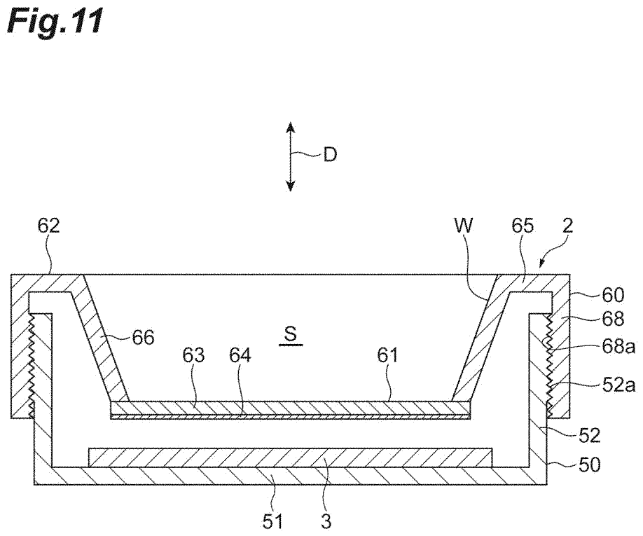

Although the embodiment of the present disclosure has been described, the present disclosure is not limited to the above-described embodiment. For example, the container 2 may have a configuration as a first modified example illustrated in FIG. 10 or a second modified example illustrated in FIG. 11. In the first modified example, a first screw portion 52a is provided on the outer surface of the end portion opposite to the bottom wall portion 51 in the side wall portion 52. The support portion 62 includes a first plate portion 65 and a fourth plate portion 68. The transmission reflection portion 61 is disposed on the first plate portion 65 so as to cover an opening portion defined by the first plate portion 65 and is connected to the first plate portion 65. The fourth plate portion 68 extends from the outer edge of the first plate portion 65 in the incident direction D. The fourth plate portion 68 is provided with a second screw portion 68a screwed to the first screw portion 52a. The second screw portion 68a is disposed in a region including the end portion opposite to the first plate portion 65 in the fourth plate portion 68. In the first modified example, the observation target cover 60 is attached to the holding member 50 by screwing the first screw portion 52a and the second screw portion 68a to each other. In this attachment state, since the first screw portion 52a and the second screw portion 68a are screwed to each other, a space between the observation target cover 60 and the holding member 50 is sealed.

In the second modified example, the support portion 62 includes the first plate portion 65, the second plate portion 66, and a fourth plate portion 68. The transmission reflection portion 61 is connected to the second plate portion 66. The fourth plate portion 68 extends from the outer edge of the first plate portion 65 in the incident direction D so as to face the second plate portion 66. The other points are the same as those of the first modified example.

In such first and second modified examples, it is possible to realize interference observation with relaxed observation conditions similarly to the above-described embodiment. Further, in the first modified example and the second modified example, since a space between the observation target cover 60 and the holding member 50 is sealed, the contamination of the observation target 3 due to foreign matter in external air can be prevented. This is particularly effective when the observation target 3 is an industrial sample. Further, since the observation target cover 60 is attached to the holding member 50 by screwing the first screw portion 52a and the second screw portion 68a to each other, the observation target cover 60 and the holding member 50 can be strongly fixed to each other. Further, it is possible to adjust a distance between the transmission reflection portion 61 and the placement surface 51a (the observation target 3) by changing the screwing amount between the first screw portion 52a and the second screw portion 68a. In the first modified example and the second modified example, the fourth plate portion 68 is located at the outside of the side wall portion 52 in the installed state, but the fourth plate portion 68 may be located at the inside of the side wall portion 52. In this case, the inner surface of the side wall portion 52 may be provided with the first screw portion 52a and the outer surface of the fourth plate portion 68 may be provided with the second screw portion 68a.

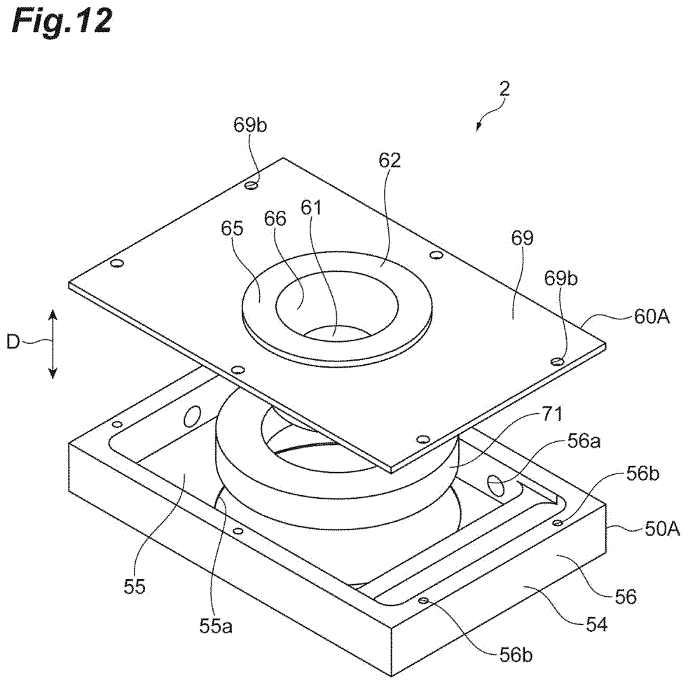

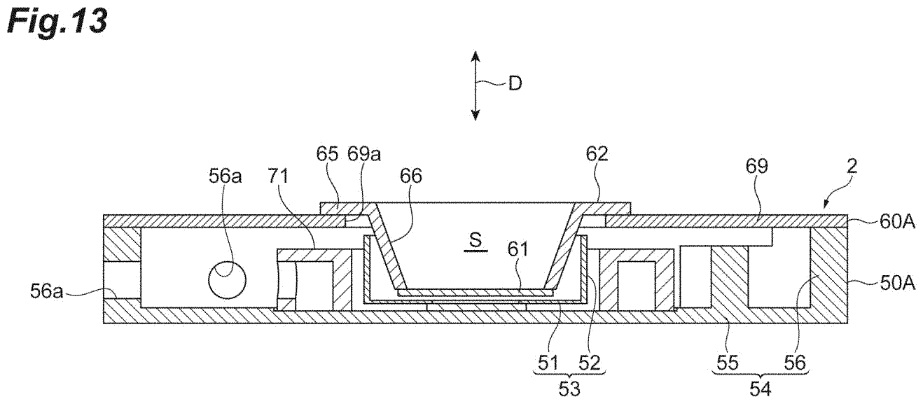

The container 2 may have a configuration as a third modified example illustrated in FIGS. 12 and 13. In the third modified example, the container 2 includes a holding member 50A, an observation target cover 60A, and a heater 71. The holding member 50A includes a dish portion 53 corresponding to the holding member 50 of the above-described embodiment and a chamber portion 54. The chamber portion 54 is formed of, for example, glass, plastic, or the like and includes a bottom wall portion 55 and a side wall portion 56. The bottom wall portion 55 is formed in, for example, a rectangular plate shape. The bottom wall portion 55 is provided with a depression 55a on which the dish portion 53 and the heater 71 are disposed. The side wall portion 56 extends from the edge of the bottom wall portion 55 in a direction orthogonal to the bottom wall portion 55. The side wall portion 56 is provided with a plurality of ventilation openings 56a.

In the observation target cover 60A, the support portion 62 includes the first plate portion 65, the second plate portion 66, and a lid 69. The lid 69 is formed in, for example, a rectangular plate shape corresponding to the shape of the bottom wall portion 55. An opening 69a having a circular cross-section corresponding to the shape of the first plate portion 65 is provided in the center portion of the lid 69. The first plate portion 65 is disposed on the lid 69 so as to cover the edge of the opening 69a and is connected to the lid 69. The second plate portion 66 protrudes from the opening 69a toward the side opposite to the first plate portion 65.

In the third modified example, the lid 69 is placed on the side wall portion 56 and the lid 69 is fixed to the side wall portion 56, so that the observation target cover 60A (the support portion 62) is attached to the holding member 50. More specifically, a plurality of screw hole 56b are provided in the front end surface of the side wall portion 56 and a plurality of through-holes 69b are provided at a position overlapping the side wall portion 56 in the lid 69. When a screw (not illustrated) passing through the through-hole 69b is fastened to the screw hole 56b, the lid 69 and the side wall portion 56 are fixed to each other. The heater 71 is provided to maintain an ambient temperature of the observation target 3 in a predetermined temperature range. The heater 71 is formed in a substantially cylindrical shape and is disposed so as to surround the dish portion 53. In such a third modified example, it is possible to realize interference observation with relaxed observation conditions similarly to the above-described embodiment.

As another modified example, in the above-described embodiment, the first light L1 and the second light L2 are separated from each other by a difference in wavelength of the transmission reflection portion 61, but the transmission reflection portion 61 may be configured to separate the first light L1 and the second light L2 by a difference in polarization component. That is, the transmission reflection portion 61 may be a polarization beam splitter. In the above-described embodiment, the observation target cover 60 may be disposed on the side wall portion 52 so that a ventilation hole is formed between the observation target cover 60 and the holding member 50. For example, a ventilation hole may be formed between the observation target cover 60 and the holding member 50 in such a manner that at least three protrusions are provided in the front end surface of the side wall portion 52 and the first plate portion 65 is supported by the protrusions. In the above-described embodiment, the holding member 50 may be omitted and the observation target cover 60 may be directly disposed on the stage 38.

In the above-described embodiment, the second plate portion 66 is formed in a tapered shape, but the second plate portion 66 may extend in the incident direction D. The space S may have a shape other than the circular shape, for example, a rectangular shape or the like in a cross-section orthogonal to the incident direction D. The optical layer 64 may be provided on a surface opposite to the surface 63a in the substrate 63. In this case, it is more difficult for the observation target 3 to contact the optical layer 64. In the above-described embodiment, at least one of the piezo actuator 35 and the stage 38 may be feedback controlled and for example, only the piezo actuator 35 may be feedback controlled. The material and shape of each component are not limited to the materials and shapes described above and various materials and shapes can be adopted.

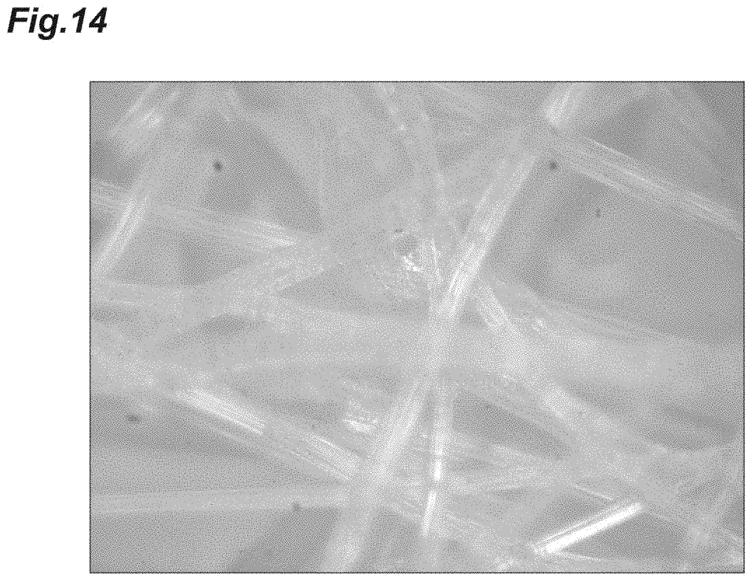

Next, a first example and a second example will be described with reference to FIGS. 14 to 17. In the first example, lens cleaning paper was used as the observation target 3. As the first light source 11, a white LED having a wavelength band of 500 nm to 700 nm and a spectrum peak wavelength of 580 nm was used. As the second light source 12, a laser diode having a wavelength of 780 nm was used. As the lens 23, a 20× objective lens without a correction ring was used. As the lens 24, a 20× objective lens with a correction ring was used. This is because the transmission reflection portion 61 is disposed between the lens 24 and the observation target 3. As the transmission reflection portion 61, a dichroic mirror having a cutoff wavelength of 720 nm, a diameter of about 25 mm, and a thickness of about 1.1 mm was used. The value of the correction ring in the lens 24 with the correction ring was set to 1.1 mm.

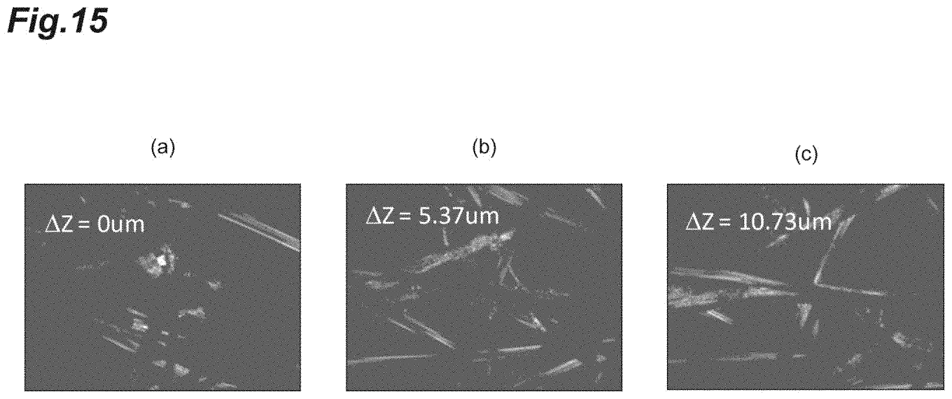

In the first example, the interference light image of the first light L1 was acquired by scanning the stage 38 through 148 steps while sequentially setting the optical path length difference G to the target value at a gap of 145 nm corresponding to ¼ of the peak wavelength 580 nm of the first light source 11. The scanning distance of the optical path length difference G is 145 nm×148 steps=21.46 μm, but since the optical path length difference G is a reciprocating value, the actual moving distance of the stage 38 is 10.73 μm. FIG. 14 is a diagram showing an example of an image extracted from 148 interference light images. From FIG. 14, it can be seen that each fiber of the lens cleaning paper is visualized. Further, in FIG. 14, interference fringes due to light reflected from the surface of each fiber are visible on the surface of the fiber. The reflected light intensity P can be obtained as an image by P=(I1−I3)²+(I2−I4)² from four consecutive interference fringe images I1, I2, I3, and I4 in which the optical path length difference G is different by each quarter wavelength of the first light L1. A stack image can be obtained by calculating the reflected light intensity P at each position of the stage 38. FIG. 15 is an example of a reflected light intensity image at three slice positions. From this stack image, a 3D rendered 3D volume image can also be obtained. Further, since one cycle of interference fringes due to light reflected from the surface of each fiber corresponds to a height difference of 290 nm, which is half the peak wavelength of 580 nm of the first light source 11, the three-dimensional distribution of the fiber at each slice position can be measured with accuracy smaller than the wavelength based on the interference fringe image.

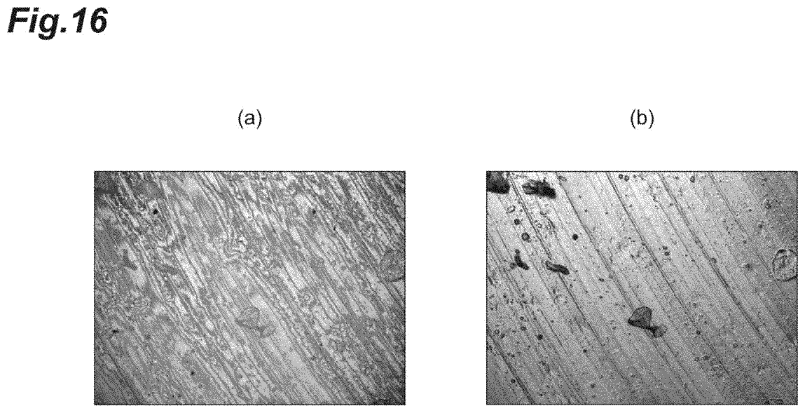

In the second example, a surface image of a metal piece was acquired by using an anodized aluminum metal piece as the observation target 3. The other points were the same as those of the first example. However, the number of steps of the phase shift was not 148 steps but only 5 steps and the phase shift was performed only by the operation of the piezo actuator 35 without performing the operation of the stage 38. FIG. 16(a) is a diagram showing an interference light image acquired in the second example. The reflected light intensity P can be obtained as an image by calculating P=(I1−2×I3+I5)²+(2×I2−2×I4)² from five consecutive interference fringe images I1, I2, I3, I4, and I5 in which the optical path length difference G is different by each quarter wavelength of the first light L1. Further, the phase ϕ of the reflected light can be obtained by calculating ϕ=arg((I1−2×I3+I5)+i×(2×I2−2×I4)). Here, arg is an operation for calculating the argument of a complex number and i is an imaginary unit.

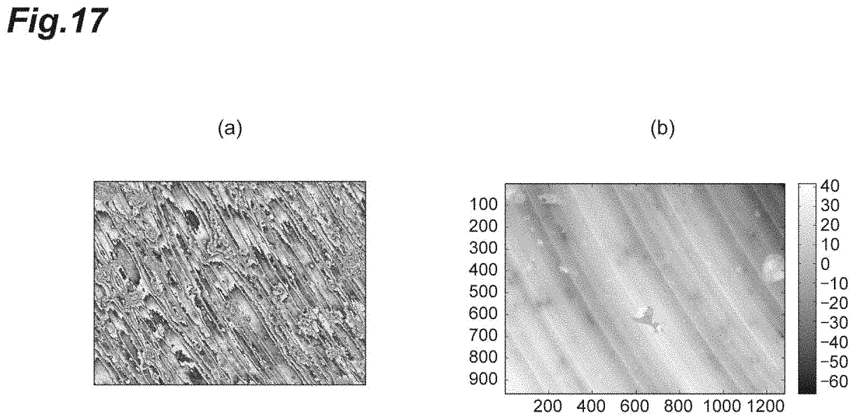

FIG. 17(a) is a diagram showing a phase image of FIGS. 16(a) and 16(b) obtained in this way and FIG. 17(b) is a diagram showing a phase image after phase unwrapping with respect to the phase image of FIG. 17(a). Since the phase corresponding to one wavelength is 2π=6.28, the images in FIGS. 17(a) and 17(b) have unevenness of about 16 times the wavelength. In the conventional method, it is difficult to obtain an interference signal for feedback of light reflected from such a rough surface. In contrast, according to the observation target cover 60, since the transmission reflection portion 61 reflects the second light L2, an appropriate feedback interference signal can be obtained also in the case of such an observation target 3. That is, there is a case in the conventional method it is difficult to sufficiently obtain a feedback control interference signal, since it is difficult to cover the observation target 3 with a coating for reflecting the second light L2 or, even if it is managed, the unevenness of the surface of the observation target 3 is too large. Even in such case, according to the observation target cover 60, since the transmission reflection portion 61 is provided as a reference reflection surface separately from the observation target 3, the S/N of the feedback interference signal can be improved.

### REFERENCE SIGNS LIST

1: interference observation device, 2: container for interference observation, 11: first light source, 12: second light source, 28: half mirror (interference optical system), 31: imaging unit (first light detector), 33: light receiving unit (second light detector), 50: holding member, 51: bottom wall portion, 51a: placement surface, 52: side wall portion, 52a: first screw portion, 60: observation target cover, 61: transmission reflection portion, 62: support portion, 63: substrate, 63a: surface, 64: optical layer, 65: first plate portion, 66: second plate portion, 67: third plate portion, 68: fourth plate portion, 68a: second screw portion, A: gap, D: incident direction, S: space, W: step.

1: An observation target cover for interference observation using first light and second light having a coherent length longer than that of the first light so as to acquire an interference light image of an observation target by the first light while adjusting an optical path length difference based on an interference result of the second light, the observation target cover comprising:
a transmission reflection portion configured to transmit the first light and reflect the second light; and
a support portion configured to support the transmission reflection portion so that a placement surface on which the observation target is placed and the transmission reflection portion face each other with a predetermined gap therebetween.

2: The observation target cover according to claim 1,
wherein the support portion includes a first plate portion and a second plate portion that is connected to the first plate portion and the transmission reflection portion so that a step is formed between the first plate portion and the transmission reflection portion and the support portion is configured to support the transmission reflection portion so that the transmission reflection portion is located on a side of the placement surface with respect to the first plate portion in an incident direction of the first light.

3: The observation target cover according to claim 2,
wherein the second plate portion extends so as to be inclined with respect to the incident direction of the first light so that a space defined by the second plate portion and the transmission reflection portion is widened as it goes away from the transmission reflection portion.

4: The observation target cover according to claim 2,
wherein a space defined by the second plate portion and the transmission reflection portion has a circular shape in a cross-section orthogonal to the incident direction of the first light.

5: The observation target cover according to claim 2,
wherein the support portion further includes a third plate portion extending from the first plate portion so as to face the second plate portion.

6: The observation target cover according to claim 1,
wherein the transmission reflection portion includes a substrate having light transmissivity and an optical layer provided on a surface facing a side of the placement surface in the substrate so as to transmit the first light and reflect the second light.

7: A container for interference observation comprising:
the observation target cover according to claim 1; and
a holding member including a bottom wall portion provided with the placement surface and a side wall portion extending from the bottom wall portion in a direction orthogonal to the placement surface,
wherein the observation target cover is configured to be disposed on the side wall portion so that the placement surface and the transmission reflection portion face each other with a predetermined gap therebetween.

8: The container for interference observation according to claim 7,
wherein the observation target cover is configured to be attached to the holding member so that a space between the observation target cover and the holding member is sealed.

9: The container for interference observation according to claim 7,
wherein the side wall portion is provided with a first screw portion,
wherein the support portion includes a fourth plate portion extending in an incident direction of the first light,
wherein the fourth plate portion is provided with a second screw portion configured to be screwed to the first screw portion, and
wherein the observation target cover is configured to be attached to the holding member by screwing the first screw portion and the second screw portion to each other.

10: An interference observation device comprising:
the observation target cover according to claim 1;
a first light source configured to output the first light;
a second light source configured to output the second light;
an interference optical system configured to output interference light of the first light and interference light of the second light;
a first light detector configured to detect the interference light of the first light;
a second light detector configured to detect the interference light of the second light; and
a holding member provided with the placement surface.

11: An interference observation method using the interference observation device according to claim 10, comprising:
a first step of placing the observation target on the placement surface;
a second step of disposing the observation target cover so that the placement surface and the transmission reflection portion face each other with a predetermined gap therebetween after the first step; and
a third step of acquiring an interference light image of the observation target by the first light while adjusting the optical path length difference based on the interference result of the second light after the second step.
